(19) United States
(12) Patent Application Publication
(10) Pub. No.: US 2022/0061543 A1
(43) Pub. Date: Mar. 3, 2022

(54) WOOL MATTRESS SET AND ITS MAKING AND RENOVATION METHODS

(71) Applicant: TEDIBER, Paris (FR)

(72) Inventor: Julien SYLVAIN, Paris (FR)

(21) Appl. No.: 17/321,440

(22) Filed: May 15, 2021

(30) Foreign Application Priority Data
Sep. 1, 2020 (EP) 20315400.0

(51) Int. Cl. A47C 27/00; A47C 27/22; A47C 31/10; A47C 31/02

(52) U.S. Cl. CPC A47C 27/001; A47C 27/22; A47C 31/026; A47C 31/023; A47C 31/105

(57) ABSTRACT

A wool mattress set includes a receiving mattress including a wool filling enclosed in a first envelope, combined with a base mattress comprising a foam filling enclosed in a second envelope. The wool filling of the receiving mattress includes a stack of one or more superposed wool mat layers, essentially devoid of wool flakes, and the receiving mattress is laid on the base mattress, the receiving mattress and the base mattress being independent and separable from each other. The foam filling of the base mattress, whose density is at least 35 kg/m³, can include in particular a material originating from foam recycling.

### CROSS REFERENCE TO RELATED APPLICATIONS

This application claims priority under 35 U.S.C. § 119(a) to European patent application no. 20315400.0 filed on Sep. 1, 2020, the entire teachings of which are incorporated herein by reference.

### BACKGROUND OF THE INVENTION

### Field of the Invention

The invention relates to wool mattresses.

### Description of the Related Art

The advantages of wool as a filling material for mattresses are well known. Its low thermal resistance provides the user with a feeling of freshness that, combined with its ability to absorb the water vapor produced by the body, offers an excellent sleeping comfort.

Furthermore, it is an entirely natural material, which is available in abundance, sustainable and low-cost. Moreover, the wool mattresses can be renovated several times while keeping the original filling, after cleaning, re-carding, refurbishing and changing the external ticking.

Nevertheless, wool suffers from such drawbacks that foam or latex are more and more preferred to it as a filling material for mattresses.

Firstly, wool mattresses deform over time and must be regularly turned over, which is often not done by the users because such a mattress is heavy. In any case, in the long run, the wool settles and sags and does not offer as good a fit and body pressure distribution as a mattress filled with foam, latex and/or with pocket springs.

Another drawback of the wool mattress lies in the fact that the comfort of a wool mattress is often determined by the type of bed base with which it is used. The mattress offering itself little support, it is highly recommended to use a wool mattress with a flexible slatted bed base, which provides a different support as a function of the parts/weights of the body. The role of the bed base is hence very important for a conventional wool mattress.

Still another drawback of the wool mattress is that it can only be made by artisanal, hence expensive, techniques.

Indeed, it has not been possible until now to industrialize in a rational way the production of wool mattresses, unlike foam or latex mattresses which can be made in a fully automated way and in large scale, hence offering the consumer relatively comfortable products at far lower prices.

For instance EP 2 078 477 A1, after having exposed in a very complete and very detailed manner all the advantages of the wool as a filling material for a “comfort layer” of a mattress, concludes by proposing to use for this comfort layer, rather than wool, a substitute material comprising a polyurethane foam in which are distributed particles of a superabsorbent polymer based on polyacrylate or polymethacrylate, in order to provide the foam with absorption capacity and breathability more or less replicating those of the wool.

US 2017/088990 A1 describes a structure comprising a mattress core providing the support, enclosed in an envelope comprising on one or both its two faces a layer formed of a sandwich of several materials. This surface layer incorporates, for the comfort, a thickness of high-density foam and one or several thicknesses of other materials, in particular wool. Such a mattress hence offers the pleasant contact of wool but, due to the low thickness of the layer, the wool provides no support function and constitutes only a very small part of the materials used for the making of the mattress.

EP 0 806 166 A2 proposes a composite mattress structure including a stack of several layers of different natures, for example four layers with, on the bed base side, a layer with a filling made of fibers (for example, coconut fibers) on which is laid a first layer of latex, itself supporting a sprung mattress, and finally a second layer of latex, on the sleeping side. These different independent structures, which are not attached to each other, are gathered in a same common fabric envelope, which can be open on three or four sides. The obtained mattress no doubt provides an excellent comfort, but its multi-composite structure is complex to make, hence expensive. Moreover, the structure is not reversible (the mattress, which is heavy, having moreover no vocation to be turned over because being not symmetrical) and, finally, the wool is considered only in a very subsidiary way and without seeking to benefit from the well known advantages of this material.

EP 2 777 435 A1 describes an orthopedic set comprising two independent and separable mattresses, with a top mattress resting on a support module that can contain in particular high-elasticity springs or foam. The top mattress is a heterogeneous structure, comparable to that of above-mentioned EP 0 806 166 A2, formed of a sandwich of stacked layers, all different from each other, with distinct functions: a “comfort” layer made of wool and/or down, acting as an interface with the underlying layer to avoid a direct contact of the latter with the patient's body; a “mechanical” layer formed of an assembly of different parts, some of them being made of high-elasticity foam and the other being made of memory-shape polymer, with hardnesses chosen according to the body regions (shoulder, torso, etc.); a “transfer” layer for capturing humidity and transferring it towards the underlying layer; a “thermal” layer formed of an assembly of parts filled with wool (for body parts that are desired to be kept warm, such as feet and shoulders) or wood chips (for body parts that are desired to be kept cold, for example torso); and a “storage” layer, made of wool and/or down, having a regulating effect to absorb humidity and heat. This orthopedic mattress has the same drawbacks as those of above-mentioned EP 0 806 166 A2

### BRIEF SUMMARY OF THE INVENTION

The purpose of the invention is to overcome these drawbacks, by proposing a new, essentially wool-based, mattress structure, whose production is industrializable and allows a significant reduction of manufacturing costs; which provides a high sleeping comfort, while keeping advantages of the wool mattress (freshness, breathability) but with a far better support than current wool mattresses, and that, independently of the support provided by the bed base; and which can be easily renovated, in a simpler (and hence cheaper) way than with current artisanal techniques, or even which can be renovated on-site at the user's home, hence without having to collect the mattress and transport it to the workshop.

The purpose is further, according to the invention, to favor an ecological approach in the design of such a mattress, which not only uses a natural material that is abundant and available for a low ecological cost—wool—, but which further provides a product that is easy to repair and renovate several times, hence with a very long potential lifespan, and consequently a significant ecological gain.

It will also be seen that the materials of different origins used for making the mattress according to the invention are not mixed, which makes it possible, at the product's end of life, to recycle separately these materials and easily insert them into respective recycling or conversion processes, hence respecting at best the principles of a “circular economy”.

The state of the art has not allowed until now achieving these objectives.

To overcome these difficulties and achieve the objectives exposed hereinabove, the invention proposes a wool mattress set comprising, in combination, a receiving mattress comprising a wool filling enclosed in a first envelope, and a base mattress comprising a foam filling enclosed in a second envelope. The receiving mattress is laid on the base mattress, and the receiving mattress and the base mattress are independent and separable from each other.

Characteristically of the invention, the wool filling of the receiving mattress comprises a stack of a plurality of superposed wool mat layers, essentially devoid of wool flakes.

According to various advantageous subsidiary features:
the receiving mattress further comprises pads formed between opposite faces of the receiving mattress, for the padding of the wool filling enclosed in the first envelope;
the stack is a stack of four to five mats of 12 cm thickness each, made of needled wool mats of 1.5 kg/m² for a thickness of 12 cm;
the foam filling of the base mattress comprise a material originating from foam recycling;
the foam filling density of the base mattress is at least 35 kg/m³;
the first and/or the second envelope are removable covers that may be open one three or four sides;
the base mattress comprises at its periphery, in particular at its four corners, tabs for centering and holding in place of the receiving mattress laid thereon;
in this latter case, the receiving mattress further comprises, at each of its four corners, a button adapted to cooperate with a buttonhole of a respective centering tab, or vice versa the receiving mattress comprises, at each of its four corners, a buttonhole adapted to cooperate with a button of a respective centering tab;
the envelope of the base mattress comprises, at least on its face in contact with the receiving mattress, an anti-slip material.

The invention has also for object a method of making such a mattress set, comprising the following steps:
obtaining, by cutting a wool roll mat, a plurality of parts whose length and width size correspond to the length and width of the receiving mattress to be made;
superposing the plurality of wool mat parts in such a way as to obtain a stack whose thickness size corresponds, as the case may be after padding, to the thickness of the receiving mattress to be made;
putting the stack into a first envelope to obtain the receiving mattress;
optionally making a padding by sewing pads between opposite faces of the receiving mattress obtained;
obtaining a foam block whose length, width and thickness sizes correspond to the respective sizes of the base mattress to be made; and
putting the foam block into a second envelope, to obtain the base mattress.

This method can further comprise a final step of rolling the receiving mattress and packaging the obtained roll for shipping, and/or rolling the base mattress separately from the receiving mattress, and packaging the obtained roll for shipping.

The invention has also for object a method of renovating such a mattress set, comprising the following steps:
opening the first envelope enclosing the filling of the receiving mattress, as the case may be after removal of the padding pads;
removing the plurality of wool mats from the stack;
re-carding the wool of the plurality of wool mats of the stack;
reconstituting the stack of wool mats; and
putting back the stack of wool mats into the first envelope of the receiving mattress; and
optionally re-padding the receiving mattress.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is an exploded perspective view showing the different elements of the mattress set according to the invention.

FIG. 2 is a sectional view along a longitudinal vertical plane of the mattress set according to the invention.

FIG. 3 schematically illustrates the different steps of the method of making the mattress set according to the invention.

### DETAILED DESCRIPTION OF THE INVENTION

An exemplary embodiment of the invention will now be described, with reference to the appended drawings in which the same references denote throughout the figures identical or functionally similar elements.

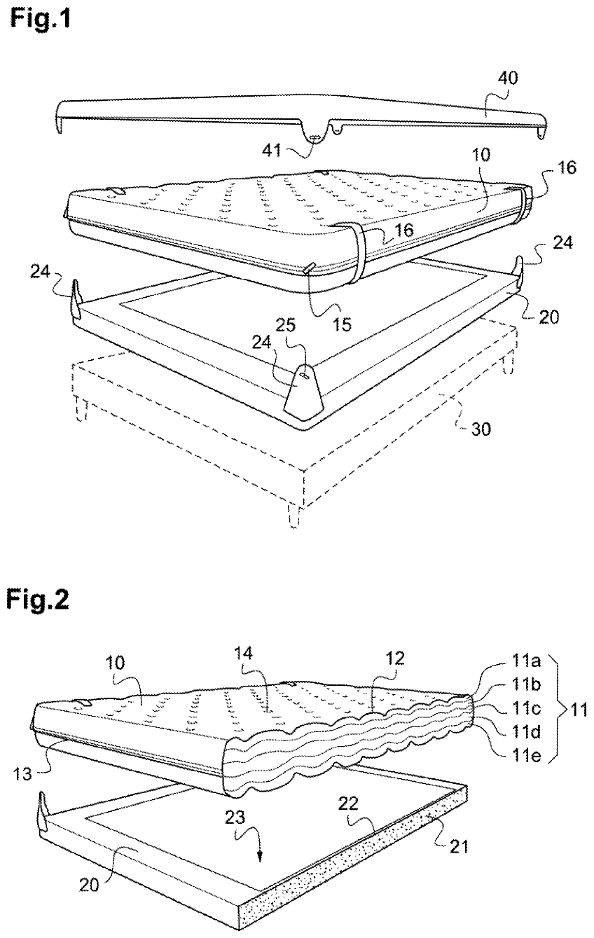

As illustrated in FIGS. 1 and 2, the mattress set according to the invention essentially includes a receiving mattress 10 resting on a base mattress 20. The receiving mattress 10 and base mattress 20 are independent and separable from each other, the receiving mattress 10 resting freely on the base mattress 20. Advantageously, the mattresses 10 and/or 20 are reversible mattresses.

This set of two mattresses 10, 20 is normally intended to rest on a bed base 30 (that is not part of the invention). Moreover, a draw sheet 40 advantageously covers the upper face of the receiving mattress 10, in contact with the user, so as to protect the mattress at this place.

Characteristically of the invention, the receiving mattress 10 is a mattress comprising a wool filling 11, whereas the base mattress 20 is a mattress comprising a foam filling 21.

The wool filling 11 of the receiving mattress 10 is, also characteristically of the invention, formed of a stack of superposed wool mat layers, in the example illustrated, five layers 11a . . . 11e of wool mat.

A typical filling composition 10 is, for example and in a non-limitative way, a stack of four to five wool mats, of for example 12 cm thickness each. The wool used can be for example a wool mat (needled), for example of 1.5 kg/m² for a thickness of 12 cm.

The wool filling 11 is enclosed in an envelope 12, for example an envelope in the form of a cover closed on three sides by a zipper 13. The cover of the envelope 12 can be in particular a linen cover, for the comfort (thermal regulation) and its ecological nature.

Advantageously, pads 14 are made over the whole extent of the mattress, the number of pads being function of the desired firmness for the mattress. Advantageously, these pads can be of a different color on each respective side of the receiving mattress 10, so the user can remember whether he has turned the mattress over or not. Lateral handles 16 can be provided to facilitate the wool receiving mattress turn-over operation.

In the example indicated hereinabove of a stack of four to five mats of 12 cm each, the total thickness of the receiving mattress 10 will be of the order of 15 cm after padding, taking into account the compression exerted on the wool mats by the padding.

It will be noted however that, unlike a conventional mattress made with a wool flake filling, padding is not necessary for the receiving mattress of the invention, because the needled material of the wool mat will not move inside envelope 12—contrary to a conventional wool flake filling.

The firmness of the receiving mattress 10 can potentially be adjusted per areas using for example wool flakes at some specific places of the mattress (such as shoulders and hips). It is also possible to interpose between two wool mat layers an intercalary wool flake layer.

The firmness of the receiving mattress can also be adjusted by inserting a firmer or denser wool mat layer over all or part of the mattress and/or in certain specific regions such as shoulders and hips.

The base mattress 20 itself comprises a foam filling 21 enclosed in an envelope 22, for a polyester cover.

The foam used is, for example and in a non-limitative way, a foam of 80 kg/m³, for example a plate of 8 cm thick (it is also possible to use a less dense but thicker foam).

The choice of a relatively dense foam, preferably higher than 35 kg/m³, allows obtaining a very firm base mattress 20 that provides in itself a firm and sustainable support, so that the bed base 30 that will support the base mattress 20 would not have, by itself, a role of support. This allows avoiding the expensive slatted and sprung bed bases, which are necessary in the case of conventional wool mattresses (wool flake mattresses, where the mattress is directly laid on the bed base).

The material used for the filling foam 21 is advantageously a flexible polyurethane foam coming from recycling, i.e. a composite foam obtained from foam scraps and flakes sorted out and mixed with a binder. Various foam recycling techniques are known, such as rebound foam or fiber bonded foam, providing plate- or roll-shaped foam blocks perfectly suited to a use within the framework of the invention for the making of the base mattress 20 supporting the wool receiving mattress 10.

The face 23 of the base mattress 20 that will be in contact with the lower face of the receiving mattress 10 is advantageously provided with an anti-slip fabric in order to maximize the adhesion and to avoid that the receiving mattress 10 slips on the base mattress 20 on which it is laid. If it is desired that the base mattress 20 can turned over, each of the two faces of the mattress will be equipped with such an anti-slip fabric.

Advantageously, the two mattresses are joined by centering and holding tabs 24 attached at the four corners of the envelope 22 of the base mattress 20, advantageously reversible textile tabs if it is desired that the base mattress 20 can be turned over, so that the tabs 24 can always be directed upward after the mattress has been turned over. These tabs can further comprise a buttonhole 25 adapted to cooperate with a respective button 15 of the receiving mattress 10 (or vice versa the tab 24 can comprise a button adapted to cooperate with buttonhole of a textile part integral with the receiving mattress 10).

The button 15 of the receiving mattress 10 can further be passed into a buttonhole 41 integral with the bedsheet 40 at each corner of the latter, which allows maintaining the bedsheet taut on the wool receiving mattress 10.

It will be noted that, thanks to this reversible attachment system, the mattresses are both able to be turned over independently in the two dimensions (top/bottom and head/feet), which allows keeping an almost uniform support and extending the lifespan of the set.

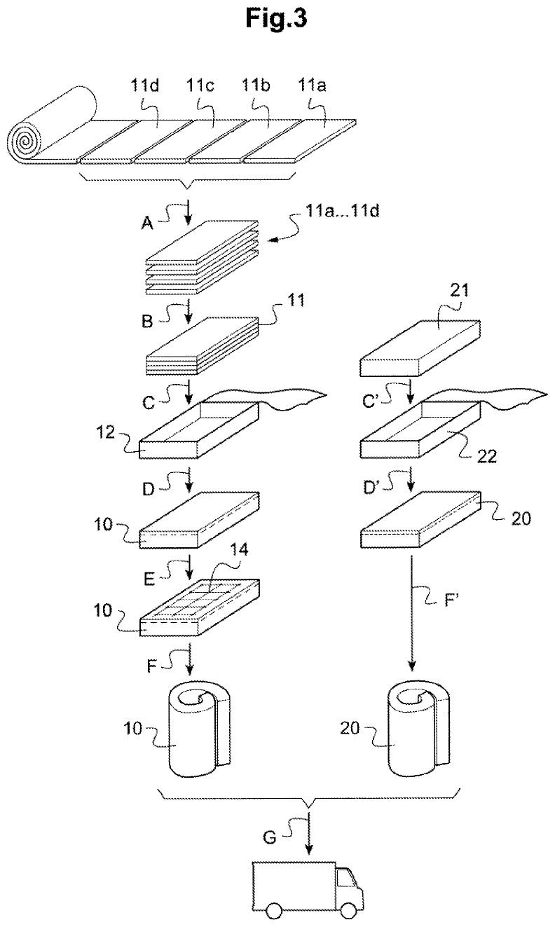

It will now be described, with reference to FIG. 3, an exemplary process of making the just-described mattress set.

For making the receiving mattress 10, a rolled wool mat is cut in such a way as to obtain (step A) parts 11a, . . . 11d whose length and width sizes correspond to the length and width of the receiving mattress to be made. These wool mat parts are stacked (step B) so as to form the wool filling 11. This filling 11 is placed (step C) into the envelope 12, which is a pre-sewn cover provided with a zipper on three or four of its sides. Once this cover closed (step D), the obtained receiving mattress 10 is advantageously (but not necessarily) subjected to a padding (step E), the number of pads 14 to be made depending on the firmness desired for the mattress. The so-made receiving mattress 10 can be rolled (step F), this packaging being made possible thanks to the smaller thickness and the matting, which would not be possible with conventional mattresses based of wool flakes, far ticker and extremely difficult to roll.

For the base mattress, a foam block 21 is cut to the desired length, width and thickness sizes, and placed (step C′) into its envelope 22, here again advantageously made as a pre-sewn cover provided with a zipper on three or four of its sides. After the closure (step D′), the base mattress 20 is advantageously rolled (step F′), so that, at the end of the process, two distinct rolls 10, 20 easy to package, handle and transport are obtained (step G).

The composite mattress structure according to the invention also perfectly suits to the renovation. In particular, the part the most easily damaged, namely the wool receiving mattress 10, is not only easy to turn over to reduce the degradations, but can be separated from the base mattress 20 to be taken to an upholsterer, or even re-carded at home. For that purpose, it is just needed, after having cut the pads, to uncover the wool filling 11 and to card it. This carding is facilitated due to the shaping of the wool as mats and not as flakes. The carding can actually be carried out easily with spikes, according toper se conventional techniques. The re-carded wool mats are then put back into the cover, then repadded.

If the original cover is stained, it can be easily washed or replaced by a new cover (and the same for the base mattress 20 is necessary). It will be noted that, unlike conventional techniques of wool mattress renovation, it is not necessary to unsew nor change the envelope, insofar as the wool mat filling is simply housed in a reclosable cover.

A repairable product is hence obtained, which multiplies its lifespan: the wool part can be easily re-carded every five to ten years, whereas the foam base suffers little or no damage over time. It will be noted that the reparability offers a significant ecological gain for this type of product, which is currently not reparable.

Moreover, at the end of life, the materials of different origins (wool/foam) can be easily separated, which allows an easier conversion thereof. As no matter is mixed, it will be easy to reinsert them into respective specific recycling or conversion processes.

Of note, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes”, and/or “including,” when used in this specification, specify the presence of stated features, integers, steps, operations, elements, and/or components, but do not preclude the presence or addition of one or more other features, integers, steps, operations, elements, components, and/or groups thereof.

As well, the corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

1. A wool mattress set comprising:
a receiving mattress comprising a wool filling enclosed in a first envelope; and
a base mattress comprising a foam filling enclosed in a second envelope,
the receiving mattress being laid on the base mattress, and the receiving mattress and the base mattress being independent and separable from each other,
wherein the wool filling of the receiving mattress comprises a stack of a plurality of superposed wool mat layers, essentially devoid of wool flakes.

2. The mattress set according to claim 1, wherein the receiving mattress further comprises pads formed between opposite faces of the receiving mattress, for the padding of the wool filling enclosed in the first envelope.

3. The mattress set according to claim 1, wherein the stack is a stack of four to five mats of 12 cm thickness each, made of needled wool mats of 1.5 kg/m² for a thickness of 12 cm.

4. The mattress set according to claim 1, wherein the foam filling of the base mattress comprises a material originating from foam recycling.

5. The mattress set according to claim 1, wherein the density of the foam filling of the base mattress is of at least 35 kg/m³.

6. The mattress set according to claim 1, wherein the first and/or the second envelope are removable covers that may be open one three or four sides.

7. The mattress set according to claim 1, wherein the base mattress comprises at its periphery, in particular at its four corners, tabs for centering and holding in place of the receiving mattress laid thereon.

8. The mattress set according to claim 7, wherein the receiving mattress further comprises, at each of its four corners, a button adapted to cooperate with a buttonhole of a respective centering tab, or vice versa the receiving mattress comprises, at each of its four corners, a buttonhole adapted to cooperate with a button of a respective centering tab.

9. The mattress set according to claim 1, wherein the envelope of the base mattress comprises, at least on its face in contact with the receiving mattress, an anti-slip material.

10. A method of making a mattress set, comprising:
obtaining, by cutting a wool roll mat, a plurality of parts whose length and width size correspond to the length and width of the receiving mattress to be made;
superposing the plurality of wool mat parts in such a way as to obtain a stack whose thickness size corresponds, as the case may be after padding, to the thickness of the receiving mattress to be made;
putting the stack into a first envelope to obtain the receiving mattress;
optionally making a padding by sewing pads between opposite faces of the receiving mattress obtained;
obtaining a foam block whose length, width and thickness sizes correspond to the respective sizes of the base mattress to be made; and
putting the foam block into a second envelope, to obtain the base mattress.

11. The method according to claim 10, further comprising:
rolling the receiving mattress and packaging the obtained roll for shipping; and further rolling the base mattress separately from the receiving mattress, and packaging the obtained roll for shipping.

12. A method of renovating such a mattress set, comprising:
opening the first envelope enclosing the filling of the receiving mattress, as the case may be after removal of the padding pads;
removing the plurality of wool mats from the stack;
re-carding the wool of the plurality of wool mats of the stack;
reconstituting the stack of wool mats; and
putting back the stack of wool mats into the first envelope of the receiving mattress; and

13. The method of claim 12, further comprising re-padding the receiving mattress.
